(19) United States
(12) Patent Application Publication
(10) Pub. No.: US 2015/0275901 A1
(43) Pub. Date: Oct. 1, 2015

(54) HEAT DISSIPATING MODULE FOR ELECTRONIC DEVICE

(71) Applicant: HON HAI PRECISION INDUSTRY CO., LTD., New Taipei (TW)

(72) Inventor: CHIH-HAO YANG, New Taipei (TW)

(21) Appl. No.: 14/541,869

(22) Filed: Nov. 14, 2014

(30) Foreign Application Priority Data
Mar. 26, 2014 (TW) 103111341

(51) Int. Cl. F04D 17/10; F04D 29/58; F04D 25/06; G06F 1/20; F04D 29/42

(52) U.S. Cl. CPC F04D 17/10; G06F 1/20; F04D 29/424; F04D 25/06; F04D 29/584

(57) ABSTRACT

An electronic device with a heat dissipating module includes a chassis and a fan mounted in the chassis. The fan includes a top panel and a bottom panel. A first airflow inlet is defined in the top panel. A second airflow inlet is defined in the bottom panel. An area of the first airflow inlet is greater than an area of the second airflow inlet. A thickness of the fan along a first direction substantially parallel to a rotational axis of the fan is less than a thickness of the chassis.

### CROSS-REFERENCE TO RELATED APPLICATIONS

This application claims priority to Taiwanese Patent Application No. 103111341 Mar. 26, 2014, the contents of which are incorporated by reference herein.

### FIELD

The subject matter herein generally relates to the cooling of electronic device.

### BACKGROUND

A heat dissipating module is used to cool an electronic device.

### BRIEF DESCRIPTION OF THE DRAWINGS

Implementations of the present technology will now be described, by way of example only, with reference to the attached figures.

FIG. 1 is an exploded, isometric view of an embodiment of an electronic device.

FIG. 2 is an isometric view of a fan of the electronic device of FIG. 1.

FIG. 3 is an isometric, assembled view of the electronic device of FIG. 1.

FIG. 4 is a cross sectional view along line IV-IV of FIG. 3, the fan of the electronic device of FIG. 1 being in a first position.

FIG. 5 is similar to FIG. 4, but the fan being in a second position.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “comprising, but not necessarily limited to”; it specifically indicates open-ended inclusion or membership in the so-described combination, group, series, and the like.

The present disclosure is described in relation to an electronic device with a heat dissipating module.

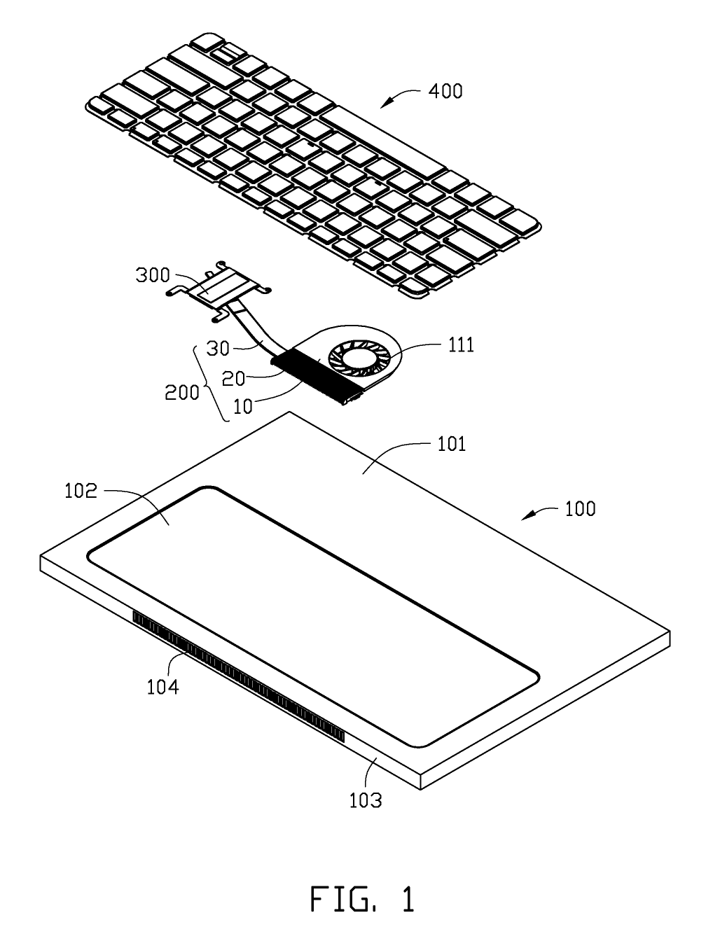

FIG. 1 illustrates an embodiment of an electronic device. The electronic device comprises a chassis 100 and a heat dissipating module 200. The heat dissipating module 200 comprises a fan 10, a heat sink 20, and a heat conducting member 30. One end of the heating conducting member 30 is coupled to the heat sink 20. The other end of the heating conducting member 30 is coupled to a heat generating member 300. The heat sink 20 comprises a plurality of fins (not labeled). In at least one embodiment, the electronic device can be a notebook or a panel computer; the heat generating member 300 can be a CPU or a north bridge chip.

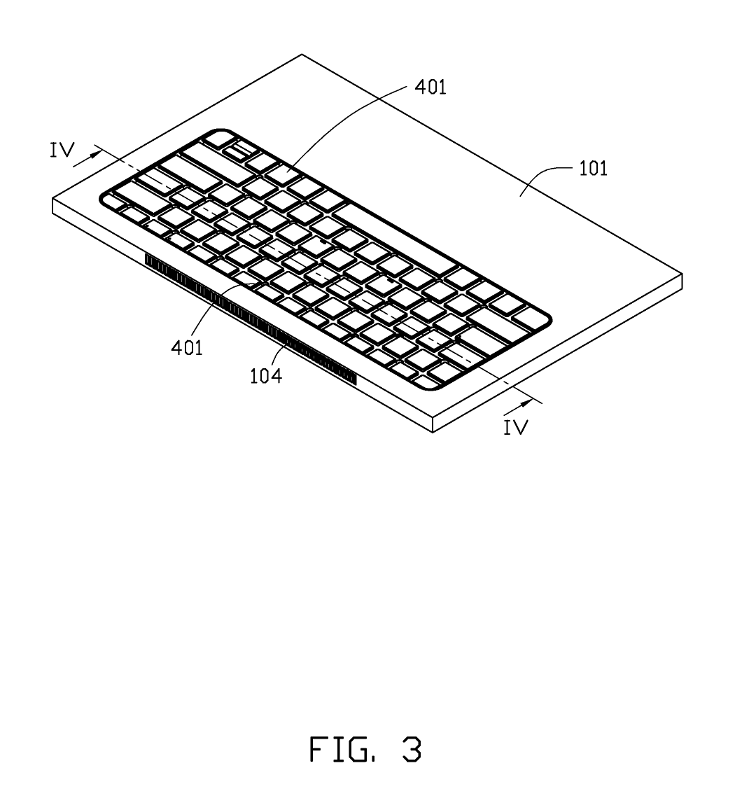

The chassis 100 comprises a top wall 101, a bottom wall (not labeled) substantially parallel to the top wall 101, and a sidewall 103 substantially perpendicularly coupled between the top wall 101 and the bottom wall. The top wall 101 defines a receiving opening 102. A keyboard module 400 is received in the receiving opening 102. The keyboard module 400 defines a plurality of heat dissipating holes 401 (shown in FIG. 3). The sidewall 103 defines a heating dissipating opening 104. In one embodiment, the heating dissipating opening 104 is substantially lattice-shaped and the receiving opening 102 is substantially square.

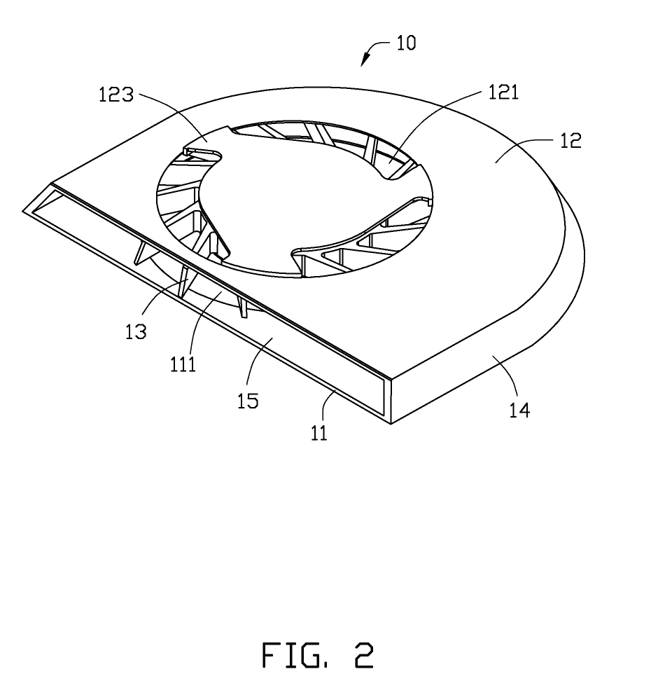

FIGS. 1 and 2 illustrate that the fan 10 comprises a top panel 11, a bottom panel 12 substantially parallel to the top panel 11, and a side panel 14 coupled between the top panel 11 and the bottom panel 12. The top panel 11 defines a first airflow inlet 111. The bottom panel 12 defines a receiving portion (not labeled). The receiving portion comprises a second airflow inlet 121 and a receiving space (not labeled). A mounting piece 123 is mounted in the receiving space. A mounting post (not labeled) is mounted in an inside of the mounting piece 123. A rotor 13 is rotatably mounted in the mounting post and is located between the top panel 11 and the bottom panel 12. The fan 10 can rotate. The fan 10 defines an airflow outlet 15. The airflow outlet 15 is cooperatively defined by the side panel 14, the top panel 11, and the bottom panel 12. The airflow outlet 15 faces the heat dissipating opening 104. The airflow outlet 15 can guide the airflow to flow out of the fan 10 in a first direction substantially perpendicular to the rotational axis of the fan 10. The first airflow inlet 111 and the second airflow inlet 121 can guide the airflow to flow into the fan 10 in a second direction substantially in line with the axis of rotation of the fan 10.

In the embodiment, the side panel 14 is substantially beveled or dome-shaped, the first airflow inlet 111 is substantially circular and an area of the cross section of the top panel 11 is greater than an area of the cross section of the bottom panel 12. An area of the first airflow inlet 111 is greater than an area of the second airflow inlet 121, and a first maximal distance between the top panel 11 and the bottom panel 12 is less than a second maximal distance between the bottom wall and the top wall 101.

FIGS. 3-5 illustrate that in assembly, the heat dissipating module 200 and the heat generating member 300 are mounted in the chassis 100. The keyboard module 400 is mounted in the receiving opening 102. Warm or hot air from the electronic device can flow into the first airflow inlet 111 via the heat dissipating holes 401. The fan 10 can urge the warm or hot air to flow out of the electronic device via the airflow outlet 15.

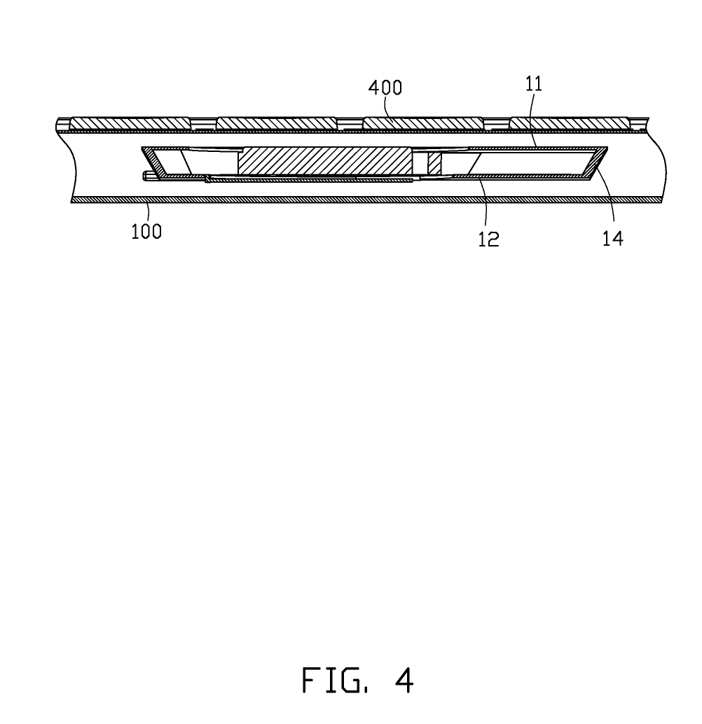

FIG. 4 illustrates the fan 10 mounted in a first position. The bottom wall, the bottom panel 12, the top wall 101, and the top panel 11 are substantially parallel to each other. A first space (not labeled) is defined between the top panel 11 wall and the top wall 101. The airflow can enter the fan through the first airflow inlet 111 in a first direction substantially in line with the axis of rotation of the fan 10. A second space (not labeled) is defined between the bottom wall and the bottom panel 12. Through this second space air can enter the fan through the second airflow inlet 121 in a second opposite to the first direction.

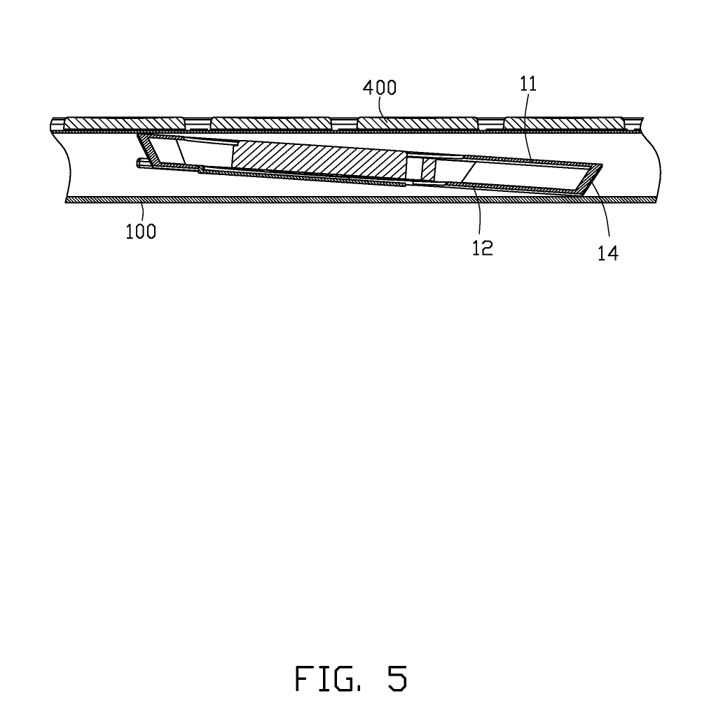

FIG. 5 illustrates the fan 10 mounted in a second position. The bottom wall touches the bottom panel 12 and the top wall 101 touches the top panel 11. A first acute angle is defined between the top wall 101 and the top panel 11, and a second acute angle is defined between the bottom wall and the bottom panel 12. A third maximal distance between the top panel 11 and the top wall 101 is greater than that when the fan 10 mounted in the first position. A fourth maximal distance between the bottom panel 12 and the bottom wall is greater than that when the fan 10 mounted in the first position.

It is to be understood that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device comprising:
a chassis, and
a fan mounted in the chassis and having:
a top panel having a first airflow inlet defined therein, and
a bottom panel having a second airflow inlet defined therein;
wherein an area of the first airflow inlet is greater than an area of the second airflow inlet; and
a thickness of the fan along a first direction substantially parallel to a rotational axis of the fan is less than a thickness of the chassis.

2. The electronic device of claim 1, wherein the fan defines an airflow outlet located between the top panel and the bottom panel, the airflow outlet can enable warm or hot air to flow out of the fan in a second direction substantially perpendicular to the rotational axis of the fan.

3. The electronic device of claim 1, wherein the chassis defines a heat dissipating opening, the heat dissipating opening is substantially lattice-shaped, and the airflow outlet faces to the heat dissipating opening.

4. The electronic device of claim 3, further comprises a heat sink and a heat conducting member coupled to the heat sink, wherein the heat sink and the airflow outlet are on the same side of the fan.

5. The electronic device of claim 2, wherein the fan further comprises a side panel coupled between the top panel and the bottom panel, and the airflow outlet is cooperatively defined by the side panel, the top panel, and the bottom panel.

6. The electronic device of claim 5, the side panel is substantially dome-shaped.

7. The electronic device of claim 1, wherein an area of the cross section of the top panel is greater than an area of the cross section of the bottom panel.

8. The electronic device of claim 1, wherein the first airflow inlet and the second airflow inlet can enable the airflow to flow into the fan in the first direction.

9. The electronic device of claim 1, wherein the chassis comprises a top wall, the top wall defines a receiving opening, a keyboard module is received in the receiving opening, and the keyboard module defines a heat dissipating hole corresponding to the first airflow inlet.

10. An electronic device comprising:
a chassis, and
a fan mounted in the chassis and having:
a top panel having a first airflow inlet defined therein, and
a bottom panel having a second airflow inlet defined therein;
wherein an area of the cross section of the top panel is greater than an area of the cross section of the bottom panel;
an area of the first airflow inlet is greater than an area of the second airflow inlet; and
a maximal distance between the top panel and the bottom panel is less than a thickness of the chassis.

11. The electronic device of claim 10, wherein the fan defines an airflow outlet located between the top panel and the bottom panel, the airflow outlet can enable the warm or hot air to flow out of the fan in a first direction substantially perpendicular to a rotational axis of the fan, and the first airflow inlet and the second airflow inlet can enable the warm or hot air to flow into the fan in a second direction substantially parallel to the rotational axis of the fan.

12. The electronic device of claim 10, wherein the chassis defines a heat dissipating opening, the heat dissipating opening is substantially lattice-shaped, and the airflow outlet faces to the heat dissipating opening.

13. The electronic device of claim 12, further comprises a heat sink, a heat conducting member, and a heat generating member, wherein the heat sink and the airflow outlet are on the same side of the fan, one end of the heat conducting member is coupled to the heat sink, and the other end of the heat conducting member is coupled to the heat generating member

14. The electronic device of claim 10, wherein the fan further comprises a side panel coupled between the top panel and the bottom panel, and the airflow outlet is cooperatively defined by the side panel, the top panel, and the bottom panel.

15. The electronic device of claim 14, wherein the side panel is substantially dome-shaped.

16. The electronic device of claim 10, wherein the chassis comprises a top wall, the top wall defines a receiving opening, a keyboard module is received in the receiving opening, and the keyboard module defines a heat dissipating hole corresponding to the first airflow inlet.

17. The electronic device of claim 16, wherein the chassis further comprises a bottom wall, when the fan is in a first position, the bottom wall is substantially parallel to the bottom panel, and a space is defined between the bottom wall and the bottom panel.

18. The electronic device of claim 17, wherein when the fan is in a second position, the bottom wall touches the bottom panel, and an acute angle is defined between the bottom wall touches the bottom panel.

19. A fan comprising:
a top panel defining a first airflow inlet;
a bottom panel defining a second airflow inlet; and
a side panel coupled between the top panel and the bottom panel,
wherein an area of the cross section of the top panel is greater than an area of the cross section of the bottom panel;
an area of the first airflow inlet is greater than an area of the second airflow inlet; and
the side panel is substantially dome-shaped.

20. The fan of claim 19, wherein the fan defines an airflow outlet, the airflow outlet is cooperatively defined by the side panel, the top panel, and the bottom panel, the airflow outlet can enable the warm or hot air to flow out of the fan in a first direction substantially perpendicular to a rotational axis of the fan, the first airflow inlet and the second airflow inlet can enable the warm or hot air to flow into the fan in a second direction substantially parallel to the rotational axis of the fan.
